(19) United States
(12) Patent Application Publication
(10) Pub. No.: US 2016/0363944 A1
(43) Pub. Date: Dec. 15, 2016

(54) METHOD AND APPARATUS FOR CONTROLLING INDOOR DEVICE

(71) Applicant: Samsung Electronics Co., Ltd., Suwon-si (KR)

(72) Inventors: Kyungjae KIM, Suwon-si (KR); Hyunsuk MIN, Suwon-si (KR); Byungcheol YU, Seoul (KR); Sangsun CHOI, Seoul (KR); Kwanwoo SONG, Yongin-si (KR); Hyejung CHO, Anyang-si (KR); Jaewook KIM, Seoul (KR)

(21) Appl. No.: 15/180,786

(22) Filed: Jun. 13, 2016

(30) Foreign Application Priority Data
Jun. 12, 2015 (KR) 10-2015-0083603

(51) Int. Cl. G05D 23/20; H04L 29/08; H04L 12/28; G05B 11/14

(52) U.S. Cl. CPC G05D 23/2037; G05B 11/14; H04L 67/12; H04L 12/282; G05B 2219/2614; G05B 2219/37375

(57) ABSTRACT

A method and an apparatus for controlling indoor devices based on the use histories of the indoor devices are provided. The method includes receiving, when an indoor device operates with a first setting value, a first bodily feeling level selected by a first user among a plurality of bodily feeling levels, determining a second setting value matching a second bodily feeling level among the plurality of bodily feeling levels based on the first bodily feeling level, indoor environment information, and use history information on a control made, by a second user, to homogeneous devices of the indoor device, and controlling the indoor device to operate with the second setting value.

### CROSS-REFERENCE TO RELATED APPLICATION(S)

This application claims the benefit under 35 U.S.C. §119(a) of a Korean patent application filed on Jun. 12, 2015 in the Korean Intellectual Property Office and assigned Serial number 10-2015-0083603, the entire disclosure of which is hereby incorporated by reference.

### TECHNICAL FIELD

The present disclosure relates to a method for controlling an indoor device. More particularly, the present disclosure relates to a method and apparatus for controlling indoor devices based on the use histories of the indoor devices.

### BACKGROUND

The Internet is evolving from the human-centric communication network in which information is generated and consumed by human to the Internet of things (IoT) in which distributed things or components exchange and process information. The combination of the cloud server-based big data processing technology and the IoT begets Internet of everything technology. In order to secure the sensing technology, wired/wireless communication and network infrastructure, service interface technology, and security technology required for implementing the IoT, recent researches are focused on the sensor network, machine to machine (M2M), and machine type communication (MTC) technologies.

In the IoT environment, it is possible to provide an intelligent IT which is capable of collecting and analyzing data generated from the connected things to create new values for human life. The IoT can be applied to various fields such as smart home, smart building, smart city, smart car or connected car, smart grid, health care, smart appliance, and smart medical service, through legacy Information Technology and convergence of various industries.

Meanwhile, various electrical devices are used in indoor situations for user convenience. For example, an accommodation facility is provided with various kinds of household devices such as a thermostat, an air conditioner, a refrigerator, a lighting control system, and a television (TV).

A guest may use some of the household electrical devices as occasion demands while staying in the accommodation facility. For example, the guest may adjust the indoor temperature using the thermostat. The guest may also manipulate the lighting control system to adjust the lighting.

However, a guest who has never visited the accommodation facility is likely to feel inconvenient to manipulate the indoor electrical devices. For example, the guest may be unfamiliar to the thermostat and thus feel difficult to adjust the indoor temperature. Even though the guest knows how to manipulate the thermostat, it may not be easy for the guest to set a target temperature accurately. There is therefore much research on how to improve the user's convenience in use of accommodation facilities.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problem and/or disadvantages and to provide at least the advantages described below. Accordingly, an aspect of the present disclosure is to provide a method for a server to provide setting values of indoor devices based on the user histories of the indoor devices.

Another aspect of the present disclosure is to provide a method for providing a user interface reflecting user's emotion to improve user's indoor device manipulation convenience.

In accordance with an aspect of the present disclosure, a method of controlling an indoor device via a server is provided. The method includes receiving, when an indoor device operates with a first setting value, a first bodily feeling level selected by a first user among a plurality of bodily feeling levels, determining a second setting value matching a second bodily feeling level among the plural bodily feeling levels based on the first bodily feeling level, indoor environment information, and use history information on a control made, by a second user, to homogeneous devices of the indoor device, and controlling the indoor device to operate with the second setting value.

In an implementation, the use history information includes a bodily feeling level used by the second user for controlling the homogeneous devices and a setting value determined based on the bodily feeling level.

In an implementation, the second user is a user who is different from the first user and has controlled the homogeneous devices.

In an implementation, the use history information includes information on the use of the homogeneous devices by the second user in at least one of identical and similar situations to the indoor situation.

In an implementation, the second setting value is determined based on user information of the first user.

In an implementation, the indoor environment information includes at least one of indoor temperature, indoor brightness, indoor sound, indoor airflow amount, and indoor sunlight amount.

In an implementation, the first bodily feeling level includes information on feeling of the user about indoor environment.

In an implementation, controlling the indoor device includes transmitting the second setting value to the indoor device directly or via a gateway.

In an implementation, the indoor device is one of a thermostat, an air conditioner, and a heater for adjusting indoor temperature.

In an implementation, the bodily feeling levels include at least one of ‘hot’, ‘warm’, ‘comfort’, ‘cool’, and ‘cold’.

In accordance with another aspect of the present disclosure, a server for controlling an indoor device is provided. The server includes a communication unit which transmits and received necessary information and a control unit which controls the communication unit to receive, when an indoor device operates with a first setting value, a first bodily feeling level selected by a first user among a plurality of bodily feeling levels, determines a second setting value matching a second bodily feeling level among the plural bodily feeling levels based on the first bodily feeling level, indoor environment information, and use history information on a control made, by a second user, to homogeneous devices of the indoor device, and controls the indoor device to operate with the second setting value.

In an implementation, the use history information includes a bodily feeling level used by the second user for controlling the homogeneous devices and a setting value determined based on the bodily feeling level.

In an implementation, the second user is a user who is different from the first user and has controlled the homogeneous devices.

In an implementation, the use history information includes information on the use of the homogeneous devices by the second user in at least one of identical and similar situations to the indoor situation.

In an implementation, the control unit determines the second setting value based on user information of the first user.

In an implementation, the indoor environment information includes at least one of indoor temperature, indoor brightness, indoor sound, indoor airflow amount, and indoor sunlight amount.

In an implementation, the first bodily feeling level includes information on feeling of the user about indoor environment.

In an implementation, the control unit controls transmitting the second setting value to the indoor device directly or via a gateway

In an implementation, the indoor device is one of a thermostat, an air conditioner, and a heater for adjusting indoor temperature.

In an implementation, the bodily feeling levels include at least one of ‘hot’, ‘warm’, ‘comfort’, ‘cool’, and ‘cold’.

In accordance with another aspect of the present disclosure, a storage medium stores a program of instructions for implementing a method of controlling an indoor device is provided. The method includes receiving, when an indoor device operates with a first setting value, a first bodily feeling level selected by a first user among a plurality of bodily feeling levels, determining a second setting value matching a second bodily feeling level among the plural bodily feeling levels based on the first bodily feeling level, indoor environment information, and use history information on a control made, by a second user, to homogeneous devices of the indoor device, and controlling the indoor device to operate with the second setting value.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram illustrating system architecture according to an embodiment of the present disclosure;

FIG. 1B is a diagram illustrating a device control operation of a server in the system according to an embodiment of the present disclosure;

FIG. 2 is a signal flow diagram illustrating a method of controlling an indoor device via a server according to an embodiment of the present disclosure;

FIG. 3 is a diagram illustrating stepwise levels depending on the type of the indoor device of FIG. 2 according to an embodiment of the present disclosure;

FIG. 4 is a flowchart illustrating a second setting value determination procedure of a server according to an embodiment of the present disclosure;

FIG. 5 is a graph illustrating correlation between the setting values and bodily feeling levels according to an embodiment of the present disclosure;

FIG. 6 is a diagram illustrating screen displays for explaining change of the bodily feeling level as the indoor temperature changes according to an embodiment of the present disclosure;

FIG. 7 is a diagram illustrating a screen display for explaining how to select a bodily feeling level for adjusting the temperature according to an embodiment of the present disclosure;

FIG. 8 is a diagram illustrating bodily feeling levels of the bodily feeling scale displayed on the screen of the display device of FIG. 7 according to an embodiment of the present disclosure;

FIG. 9 is a diagram illustrating a screen display for explaining how to select the bodily feeling level to adjust the temperature according to an embodiment of the present disclosure;

FIG. 10 is a block diagram illustrating a configuration of a server according to an embodiment of the present disclosure

FIG. 11 is a block diagram illustrating a configuration of a gateway according to an embodiment of the present disclosure; and

FIG. 12 is a flowchart illustrating an indoor device control procedure of a server according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a non-transitory computer-readable memory that can direct a computer or other programmable data processing apparatus to function in a particular manner, such that the instructions stored in the non-transitory computer-readable memory produce an article of manufacture including instruction means which implement the function/act specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide operations for implementing the functions/acts specified in the flowchart and/or block diagram block or blocks. Furthermore, the respective block diagrams may illustrate parts of modules, segments or codes including at least one or more executable instructions for performing specific logic function(s). Moreover, it should be noted that the functions of the blocks may be performed in different order in several modifications. For example, two successive blocks may be performed substantially at the same time, or may be performed in reverse order according to their functions.

As used herein, terms such as “first,” “second,” etc. are used to describe various components. However, it is obvious that the components should not be defined by these terms. The terms are used only for distinguishing one component from another component.

As used herein, the singular forms “a”, “an” and “the” are intended to include the plural forms as well, unless the context clearly indicates otherwise. It will be further understood that the terms “comprises” and/or “has” when used in this specification, specify the presence of stated feature, number, operation, component, element, or a combination thereof but do not preclude the presence or addition of one or more other features, numbers, operations, components, elements, or combinations thereof.

Throughout the specification, a module or a unit carries out at least one function or operation and may be implemented in hardware or software or as a combination of hardware and software. Also, a plurality of modules or units may be integrated into one module by at least one processor (not shown) without the exception of the module or unit which should be implemented with specific hardware.

Throughout the specification, when it is described that a part is “connected to” another part, this includes not only a case of “being directly connected to” but also a case of “being indirectly connected to” interposing another device therebetween. Also, when it is described that a component “includes” another component, this does not mean the exclusion of other components but means the inclusion of other components unless otherwise stated specifically.

Throughout the specification, a user input may include, but not limited to, at least one of a touch input, a bending input, a voice input, a button input, a motion input, and a multimodal input.

Throughput the specification, a user interaction (UI) element may be a user interactive element which generates a sensory feedback such as visual, auditory, haptic, and olfactory feedbacks.

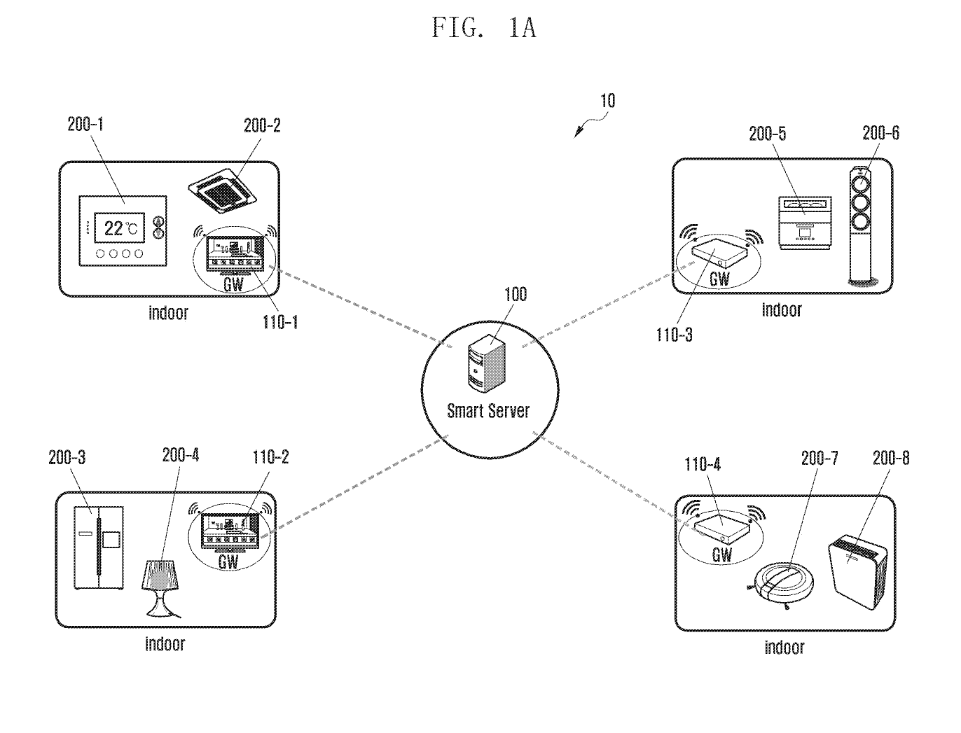

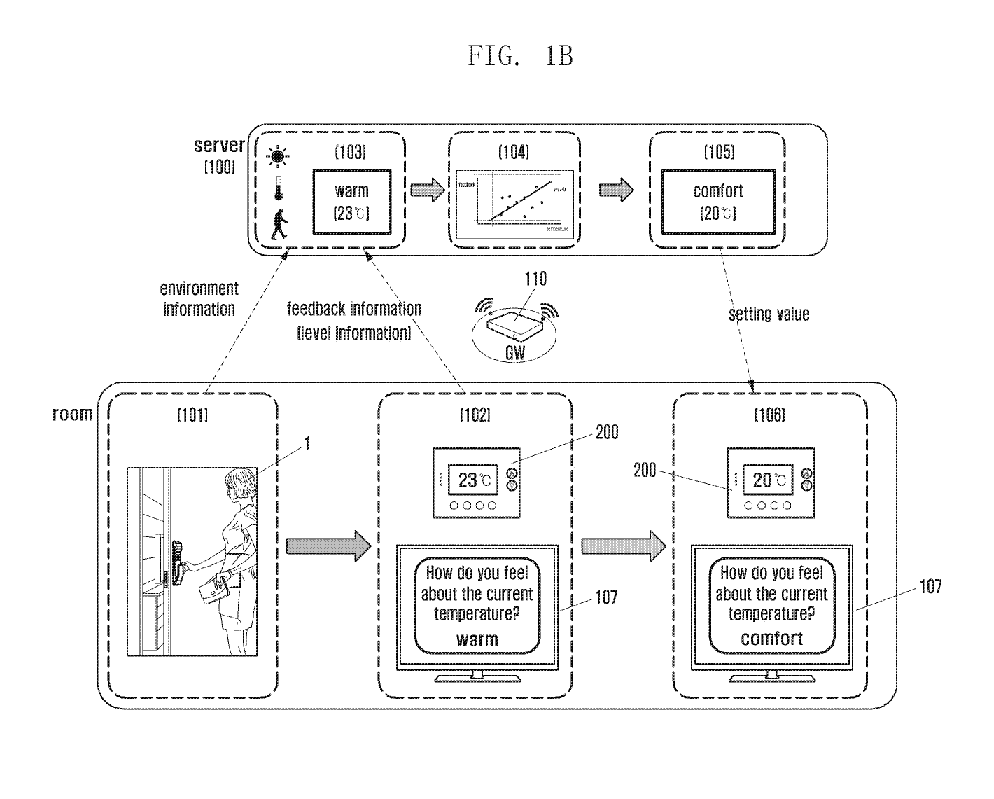

FIG. 1A is a diagram illustrating system architecture according to an embodiment of the present disclosure.

Referring to FIG. 1A, the system 10 includes a server 100 and one or more indoor areas (e.g., room, office, and a ward). The indoor areas are equipped with gateways 110-1, 110-2, 110-3, and 110-4 and indoor devices 200-1, 200-2, 200-3, 200-4, 200-5, 200-6, 200-7, and 200-8.

The indoor devices 200-1 to 200-8 may be used for user's convenience in the indoor areas. For examples, the indoor devices 200-1 to 200-8 may include a thermostat, an air conditioner, a heater, a refrigerator, a lighting device, a cooking device, a dish washer, a laundry machine, a robot cleaner, and a TV.

The gateways 110-1 to 110-4 are connected to the indoor devices 200-1 to 200-8 through wired or wireless links to communicate control information. The gateways 110-1 to 110-4 are connected to the server 110 through wired or wireless links to communicate information necessary for controlling the indoor devices 200-1 to 200-8.

For example, the gateway 110-1 may receive the information on the indoor temperature from the indoor thermostat 200-1 and send the information to the server 100. The gateway 110-1 may receive information on the user input made to the indoor thermostat 200-1 and send the information to the server 100.

Among the gateways 110-1 to 110-4, some gateways 110-3 and 110-4 are physically separated from the devices, and the others 110-1 and 110-2 may be embedded in certain indoor devices communicating with the server 100.

The server 100 may store the information concerning the operations of the system 10 which is received from the respective devices and transmit the information to the respective devices. That is, the server 100 may be connected to the area-specific gateways 110-1 to 110-4 through wired or wireless communication links to exchange information. The server 100 may be connected with the indoor devices 200-1 to 200-8 located in the respective indoor areas to exchange information directly.

For example, the server 100 may transmit setting values for controlling the indoor devices 200-1 to 200-8 to the indoor devices 200-1 to 200-8 via the gateways 110-1 to 110-4.

In detail, the server 100 may acquire user input information for controlling the indoor device 200-1 or indoor environment information from the gateway 110-1. In this case, the server may determine the setting value for controlling the indoor device 200-1 based on the use history information of the indoor device 200-1 which is stored in the server. The server 100 may transmit the determined setting value to the indoor device 200-1 via the gateway 110-1.

The system may be installed in a place where various services are provided. For example, the system may be installed in an accommodation facility such as hotel, a building, a hospital, a restaurant, an office, or a residential house. Although the description is directed to the case where the proposed system is installed in a hotel for convenience of explanation, the present disclosure is not limited thereto.

The method and apparatus of controlling an indoor device according to various embodiments of the present disclosure may be used to control the heating, ventilating, and air conditioning (HVAC) systems of a hotel. The HVAC system is installed to allow the guests to control the indoor temperature and air circulation.

The method and apparatus of controlling an indoor device according to various embodiments of the present disclosure may be used for controlling a hotel management system (HMS). The HMS may be installed for general management of the hotel such as guest management, employee management, and hotel room management.

By managing the HVAC system and HMS efficiently, it is possible to save energy consumption of the hotel, increase the profits of the hotel, and guarantee the satisfaction of the guests.

For convenience of explanation, the following description is made with one of the indoor devices 200-1 to 200-4, the device being designated by a reference numeral 200. In the disclosure, the indoor device 200 may be a thermostat. Also, one of the gateways 110-1 to 110-4 may be selected and designated by a reference numeral 110. The gateway 110 may send the server 100 the information received from the indoor device 200. The gateway 110 may also send the indoor device 200 the information received from the server 100.

FIG. 1B is a diagram illustrating a device control operation of a server in the system according to an embodiment of the present disclosure.

Referring to FIG. 1B, when guest 1 enters a hotel room as denoted by reference number 101 of FIG. 1B, the indoor device 200 (e.g., thermostat) may be operating with a first setting value.

Here, the first setting value may be an operation value of the indoor device 200 to maintain a certain indoor environment (e.g., temperature). For example, if the indoor device 200 is operating to maintain the indoor temperature at 23° C., the first setting value may include at least one of 23° C., difference between 23° C. and the current temperature, and temperature increment or decrement value targeting 23° C. The indoor device 200 may be operating to maintain the indoor temperature at 23° C. as denoted by reference number 102 of FIG. 1B. In this case, the user 1 may input a value interactively to the indoor device 200. For example, the user 1 may input a first level information representing the bodily feeling about the current indoor temperature to the indoor device 200 by means of a display 107. The first level information may be input by selecting one of multiple level items. The multiple level items may include ‘hot’, ‘warm’, ‘comfort’, ‘cool’, and ‘cold’, respectively. The multiple level items may represent the level values of −2, −1, 0, +1, and +2, respectively. In this case, the first level information may have the level value representing ‘warm’.

The server 100 may receive the first level information input interactively by the user 1 as denoted by reference number 103 of FIG. 1B. For example, the server 100 may receive the first level information via the gateway 110.

The server 100 may acquire the indoor environment information. The environment information may be the indoor temperature.

The indoor environment information may also include situation information capable of estimating the indoor situation. For example, the indoor situation information may indicate one of a door lock unlocked state, an indoor light-on state, and an indoor movement detection state. The server 100 may determine the indoor situation type representing the indoor situation based on the indoor situation information. For example, the server 100 may determine that the indoor situation type is a situation type indicating that the user 1 enters the room.

The server 100 may generate a correlation model of the user based on the first level information, indoor environment information, and the indoor device use history information of the user (e.g., guest who has been stayed there) as denoted by reference number 104.

The server 100 may determine a second setting value corresponding to the second level information based on the generated correlation model as denoted by reference number 105. For example, the server 100 may determine the second configuration value corresponding to the level information of ‘comfort’.

Here, the second setting value may be a value with which the indoor device 200 operates to maintain the environment (e.g., temperature) in which the user 1 feel comfort. For example, the second setting value may be 20° C., difference between 20° C. and the first setting value of 23° C., or a temperature decrement value targeting 20° C.

If the second setting value is determined, the server 100 may control the indoor device 200 to operate with the second setting value. For example, the server 100 may transmit the second setting value to the indoor device 200. At this time, the server 100 may transmit the second setting value to the indoor device 200 via the gateway 110.

If the second setting value is received, the indoor device 200 may operate with the second setting value as denoted by reference number 106. At this time, the indoor display 107 may display the level information corresponding to the indoor temperature on the screen as the temperature changes. For example, if the indoor temperature is 23° C., the user may input the level information of ‘warm’. In this case, if the indoor temperature drops to 21° C., the display 107 may display the level information of ‘little hot’ and then, if the temperature drops to 20° C., the level information of ‘comfort’. In this way, the indoor display 107 may display the information with the prediction of the bodily feeling of the user 1 as the indoor temperature changes.

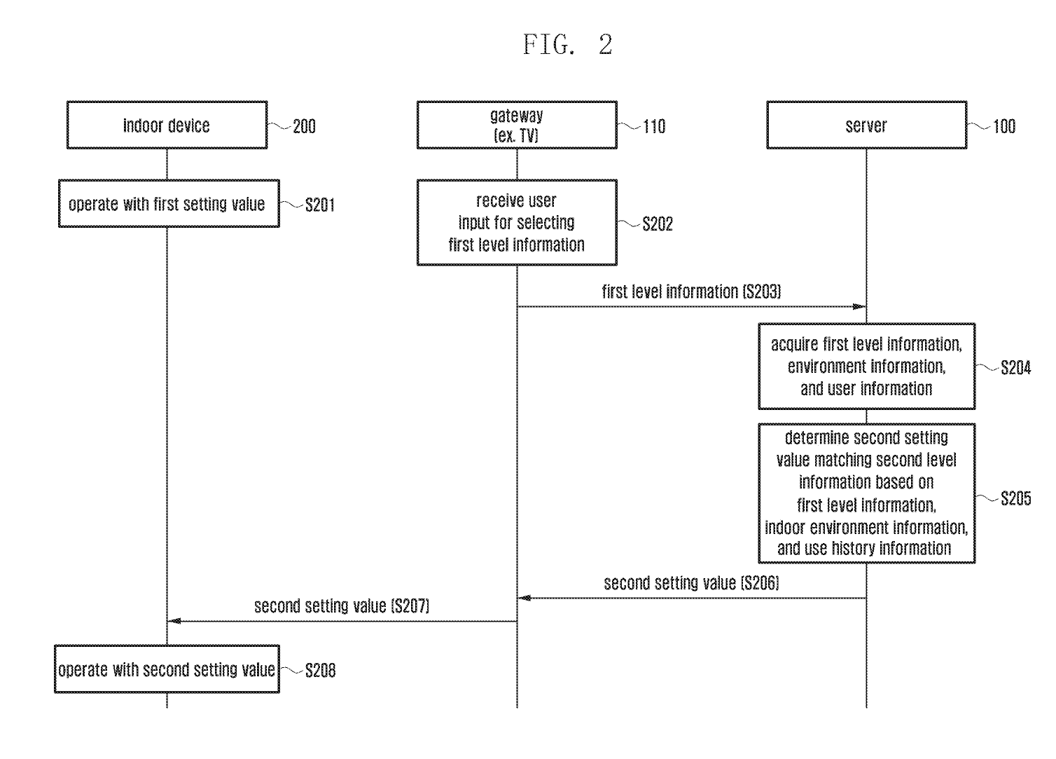

FIG. 2 is a signal flow diagram illustrating a method of controlling an indoor device via a server according to an embodiment of the present disclosure.

Referring to FIG. 2, the indoor device 200 may be operating with a first setting value at operation S201. For example, the indoor device 200 may be operating to maintain the temperature indicated by the first setting value.

The gateway 110 may receive a user input for selecting the first level information to control the indoor device 200 which is operating with the first setting value at operation S202. The first level information may indicate the bodily fleeing state of the user in the current indoor environment. The first level information may be selected among multiple level information. The multiple level information may indicate different bodily feeling states depending on the type of the indoor device 200.

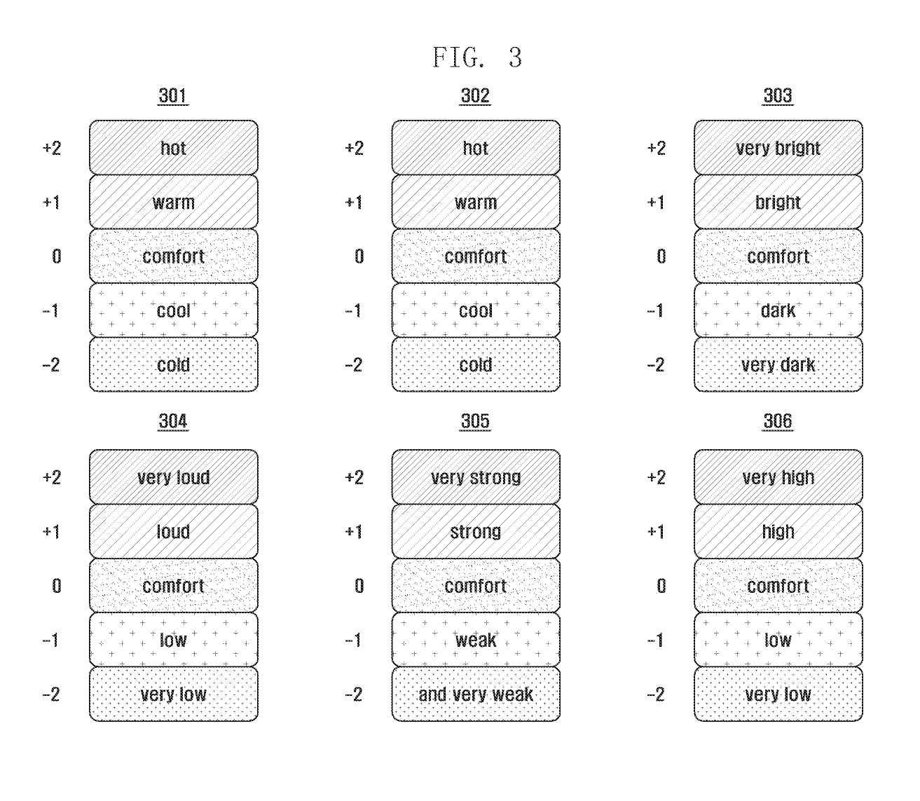

FIG. 3 is a diagram illustrating stepwise levels depending on the type of the indoor device 200 of FIG. 2 according to an embodiment of the present disclosure.

Referring to FIG. 3, the device-type specific bodily feeling scale consists of 5 levels. The 5 bodily feeling levels may be designated by level values of −2, −1, 0, +1, and +2. That is, the level information may be designated by texts representing bodily feeling states of the user or corresponding level values.

Although the bodily feeling scale consists of 5 levels herein, the number of levels is not limited thereto. For example, the scale may consist of 3, 7, 9, or more levels. In the present disclosure, the bodily feeling scale consists of 5 or 7 levels for convenience of explanation.

Part 301 of FIG. 3 shows a bodily feeling scale for a temperature-related device such as an indoor thermostat, an air conditioner, and an electric fan. In this case, the bodily feeling scale may consist of ‘hot’, ‘warm’, ‘comfort’, ‘cool’ and ‘cold’.

Part 302 of FIG. 3 shows the bodily feeling scale for a temperature-related device such as water heating control system and floor heating control system. In this case, the bodily feeling scale may consist of ‘hot’, ‘warm’, ‘comfort’, ‘cool’, and ‘cold’.

Part 303 of FIG. 3 shows the bodily feeling scale for an indoor brightness-related device such as a lighting system, a TV, and other display devices. In this case, the bodily feeling scale may consist of ‘very bright’, ‘bright’, ‘comfort’, ‘dark’, and ‘very dark’.

Part 304 of FIG. 3 shows the bodily feeling scale for a sound-related device such as a speaker, an audio system, and a TV. In this case, the bodily feeling scale may consist of ‘very loud’, ‘loud’, ‘comfort’, ‘low’, and ‘very low’.

Part 305 of FIG. 3 shows the bodily feeling scale for an air circulation-related device such as a window control system, an air cleaner, and a ventilation fan. In this case, the bodily feeling scale may consist of ‘very strong’, ‘storing’, ‘comfort’, ‘weak’, and ‘very weak’.

Part 306 of FIG. 3 shows the bodily feeling scale for a sunlight amount-related device such as a window control system, a drapery control system, a blind control system, and a curtain control system. In this case, the bodily feeling scale may consist of ‘very high’, ‘high’, ‘comfort’, ‘low’, and ‘very low’.

The levels constituting the bodily feeling scale per indoor device are represented by specific texts, and the texts may be replaced by alternative texts which can well express the bodily feelings of the user. Also, the levels of the bodily feeling scale may be represented with still images, motion images, icons, or sounds.

The user may make an input for selecting a level of the bodily feeling scale in various manners. For example, the user may make a touch input, a voice input, a button input, a sightline input, and a gesture input. The input may also be made regardless of the user's intention. For example, the user input may be automatically made based on the location, current status, and motion of the user.

Returning to FIG. 2, the gateway 110 may send the server 200 the first bodily feeling level input by the user at operation S203. At this time, the first bodily feeling level may be transmitted from the indoor device 200 to the server 100 directly.

The server 100 may receive the first bodily feeling level from the gateway 110. The server 100 may acquire indoor environment information. The server 100 may also acquire user information.

Here, the environment information may include indoor temperature, indoor brightness, indoor airflow amount, indoor sound level, and indoor sunlight amount.

The environment information may also include the environment information at the time when the user input the first bodily feeling level. In the case that the environment information is acquired periodically, the environment information may be the environment acquired most recently before receiving the first bodily feeling level. The environment information may also be the environment information acquired in a predetermined time after the receipt of the first bodily feeling level.

The environment information may be acquired along with the first bodily feeling level simultaneously or before or after acquiring the first bodily feeling level.

In the case that there are multiple environment information, the multiple environment information may be acquired at different times. For example, part of the multiple environment information may be acquired at the same time as the bodily feeling level and remaining part of the multiple environment information at a different time from the bodily feeling level.

The environment information may also include current time information, current weather information, current season information, current time zone information, current date information, and weekday/holiday information.

The environment information may also include indoor situation information. The indoor situation information is described in detail with reference to Table 1.

The user information may include the user's gender, user's age, user's nationality, number of guests, and check-in purpose.

The user information may also include user's status information. The user's status information may be the information indicating the status of the user while inputting the first bodily feeling level. If the status information is acquired periodically, the user's status information may be the information indicating the latest status of the user before receiving the first bodily feeling level. The user's status information may be the information indicating the status of the user which is acquired in a predetermined time after the receipt of the first bodily felling level.

The user's status information may be acquired at the same time as the first bodily feeling level or before or after acquiring the first bodily feeling level.

In the case that there are multiple user's status information, the multiple user's status information may be acquired at different times. For example, part of the multiple user's status information may be acquired at the same time as the bodily feeling level and remaining part of the multiple user's status information at a different time from the bodily feeling level.

The user's status information may also be acquired from a portable device carried or worn by the user as well as an indoor device. For example, the user's status information may be acquired from a smartphone, a laptop computer, a tablet device, an electronic book device, a digital broadcast device, a personal digital assistant (PDA), a portable multimedia player (PMP), a navigation device, and a wearable device (such as a smart watch, smart glasses, a head-mounted display (HMD).

The user's status information is described in detail with reference to Table 2.

Returning to FIG. 2, the server 100 may acquire the first bodily feeling level, environment information, and user information at operation S204 as described above.

The server 100 may determine a second setting value corresponding to the second bodily feeling level based on the first bodily feeling level, environment information, user information, and use history information representing the history of the previously visited user's use of the same device as the indoor device 200 at operation S205.

Here, the same device as the indoor device 200 may be a device identical with the indoor device 200 or a device for the same purpose as the indoor device 200. For example, if the indoor device 200 is a thermostat, the device for the same purpose as the indoor device 200 may be an air conditioner or an electric fan having a function of adjusting temperature. If the indoor device 200 is a refrigerator with a refrigerate function, the device for the same purpose as the indoor device 200 may be a showcase or a table having the refrigerate function.

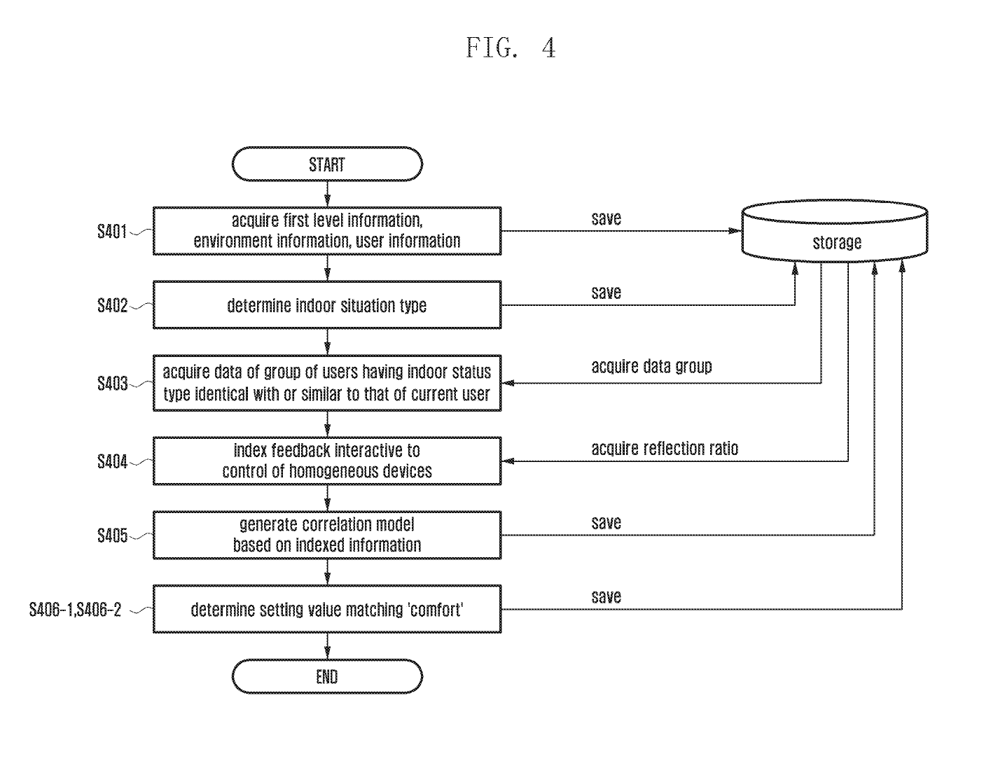

FIG. 4 is a flowchart illustrating a second setting value determination procedure of a server according to an embodiment of the present disclosure.

Referring to FIG. 4, the server 100 may acquire the first bodily feeling level, environment information (e.g., aforementioned status information), and user information at operation S401. Next, the server 100 may determine the indoor situation type based on the acquired information at operation S402.

Table 1 shows indoor situation types determined based on the indoor situation information according to an embodiment.

TABLE 1

| Situation type | indoor situation information |
|---|---|
| Absence | Door lock is locked, electric light is off, TV is off, no |
| | indoor movement is detected |
| Presence | Door lock is unlocked, electric light is on, indoor |
| | movement is detected |
| Watching | Media player is on, speaker is on |
| movie | |
| Sleeping | Evening time, electric light is off, TV is off |
| Wakeup | Alarm is on, electric light is on, Audio/Video (AV) is on |
| Cleaning | Window is open, cleaner is on, sound recognition is on |

Table 2 shows the user status types determined based on the user status information according to an embodiment. The user status types may be determined depending on the indoor situation information.

TABLE 2

| Status type | User status information |
|---|---|
| Sleeping | Blood pressure measured by wearable device drop |
| Resting | Minute indoor movement is detected, TV or audio is on, |
| | reading light is on |
| Bathing | Tap water is turned on in bathroom |
| Eating | Minute movement is detected in dining room (e.g., |
| | repetitive hand-movement to mouth) |
| Cooking | Gas oven is on, refrigerator door opening is detected, user's |
| | indoor movement is detected |
| Laundering | Laundry machine is on |
| Sick | Body temperature measured by wearable device rise, heart |
| | rate rise, excessive sweating is detected, blood pressure rise |
| | or drop |

The server 100 may store the user status type or indoor situation type in its storage. The server 100 may store the first bodily feeling level, environment information, and user information used for determining the user status type in its storage.

Next, the server 100 may acquire the data of a group of the previously visited users having the indoor status type identical with or similar to that of the current user at operation S403. The server 100 may also acquire the data of a group of the previously visited users having the user status type identical with or similar to that of the current user.

The visited user group data may include the information about the visited users' use history of the devices of the same kind as the indoor device 200. For example, the use history information may include the information about the visited users' use history of the devices of the same kind as the indoor device 200. The user history information may also include the use history information about the visited users' use history of the devices of the same kind as the indoor device 200 in other indoor environment providing specific services (e.g., hotel, business building, apartment, and hospital). The use history information may also include the information about the visited users' use history of the devices of the same kind as the indoor device 200 in other indoor environments related to a place providing specific service (e.g., hotel belonging to the same hotel chain as the hotel which the guest is staying). At this time, the previously visited user may be the guest staying in the place or a third party.

At this time, the use history information may include the previously visited user's setting values of the corresponding devices and bodily feeling levels corresponding thereto. That is, if a previously visited user input bodily feeling levels to control the corresponding device based on the indoor environment, the use history information may include the environment information, bodily feeling level of the visited user, and setting value corresponding to the bodily feeling level at the time when the corresponding device was controlled.

Next, the server 100 may index the feedback interactive to the control of the devices of the same kind as the indoor device based on the use history information of the group at operation S404. That is, the server 100 may index the visited users' setting values of the homogeneous devices in correspondence to the bodily feeling levels.

For example, if the bodily feeling scale consists of 5 levels, the setting values may be mapped to the respective level values of −2, −1, 0, +1, and +2.

In this disclosure, the level value of 0 matches the bodily feeling level of ‘comfort’. The server 100 may acquire the homogeneous devices setting values corresponding to the level value of 0 based on the use history information.

If there is no setting value matching the level value of 0, the server 100 may acquire the lastly configured setting value of the homogeneous device from the use history information.

If there is no setting value matching the bodily feeling level of 0, the server 100 may acquire the lastly configured setting value of the homogeneous device among the setting values maintained over a predetermined time period (about 30 minutes) in the use history information. At this time, the predetermined time period may vary depending on the type of the homogeneous device. For example, the time period may be set to about 1 hour for a temperature-related device. The time period may also be set to about 10 minutes for a brightness-related device. The time period may also be set to about 10 minutes for a sound-related device. The time period may also be set to about 30 minutes for an airflow amount-related device.

The server 100 may acquire a homogeneous device setting value matching a bodily feeling level with the exception of the bodily feeling level of ‘comfort’ from the use history information. For example, the server 100 may acquire setting values corresponding to the level values of +2, +1, −1, and −2 with the exception of 0.

If there are no setting values matching the other levels, the server may map the level value of −2 to the lowest setting value of the homogeneous device and the level value of +2 to the highest setting value of the homogeneous device in the user history information. The server 100 may also map the setting values corresponding to or average value or median value of the lowest 20% of the setting values of the homogeneous device to the level value of −1, the setting values corresponding to or average value or median value in the range of the lowest 20% to 50% of the setting values of the homogeneous device to the level value of −1, the setting values corresponding to or average value or median value of the highest 20% of the setting values of the homogeneous device to the level value of +2, and the setting values corresponding to or average value or median value in the range of the highest 20% to 50% of the setting values of the homogeneous device to the level value of +1.

Next, the server 100 may generate a correlation model based on the indexed information at operation S405. That is, the server 100 may generate a correlation model by applying machine learning to the indexed information to match the setting values to the bodily feeling levels. For example, it may be possible to use one of a machine learning regression analysis model, artificial neural network (ANN) model, Gaussian process model, and support vector machine (SVM) model.

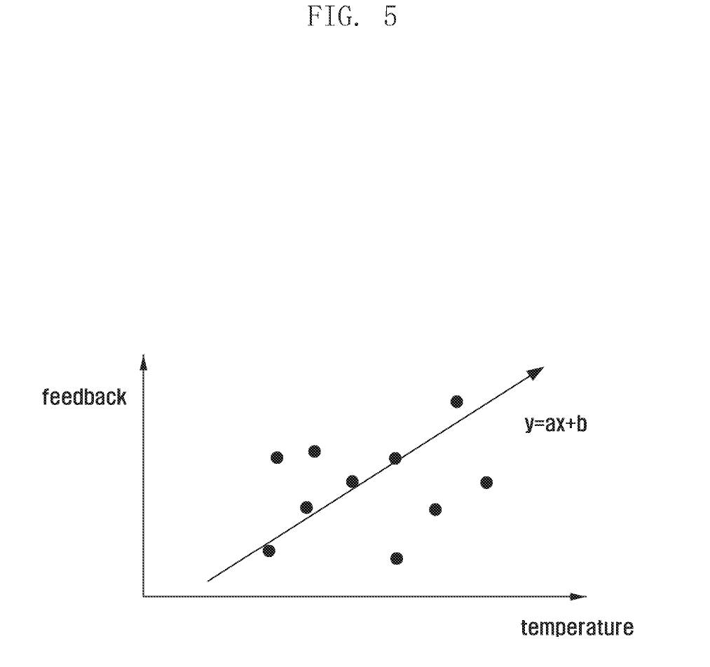

FIG. 5 is a graph illustrating correlation between the setting values and bodily feeling levels according to an embodiment of the present disclosure.

Referring to FIG. 5, the x-axis represents the temperature setting value of the indoor device 200, and y-axis represents the bodily feeling level as the user feedback to the temperature. The dots on the coordinate plane may represent the indexed information. Referring to FIG. 5, the correlation model may be expressed by y=ax+b presented as a one-dimensional graph on the coordinate plane. For example, the correlation model may be expressed by a one-dimensional graph in which the distance between dots is minimized. Although specified with an example as shown in FIG. 5, the correlation model is not limited thereto but may be expressed in the form of a 2-dimensional or 3-dimensional graph or other various forms.

The server 100 may acquire the setting value of the indoor device 200 which corresponds to the level value of 0 matching the bodily feeling level of ‘comfort’ using the correlation model.

For example, the server 100 may acquire a new value of ‘b’ by substituting the received bodily feeling scale for ‘y’ and indoor environment information (e.g., indoor temperature) for ‘x’ in the state that slope ‘a’ is fixed in Equation y=ax+b.

For example, the correlation model of the previously visited user group may be expressed by Equation 1:

y=0.28x−6.47 Equation 1

The server 100 may estimate Equation 2 of which the slope is identical with that of Equation 1 and the intercept is different from that of Equation 1 to determine the correlation model of the user.

y=0.28+b Equation 2

The server may substitute the level value corresponding to the received bodily feeling scale and a value representing the acquired indoor environment information to Equation 2. For example, if the received bodily feeling level is ‘cool’ and the indoor temperature as the acquired environment information is 23° C., the server may substitute −1 for y and 23 for x of Equation 2.

If b′ is determined as −7.44 through the substitution, the correlation model of the user may be expressed by Equation 3:

y=0.28x−7.44 Equation 3

If the correlation model of the user is determined, the server may determine the setting value corresponding to the bodily feeling level of ‘comfort’ using the correlation model at operation S406-1.

That is, the server 100 may substitute the level value of 0 representing ‘comfort’ for y of Equation 3.

With this substitution, the correlation model of the user may be expressed by Equation 4:

0−0.28x−7.44 Equation 4

In Equation 4, x becomes 26.57. The server 100 may change the indoor temperature to the value of x.

According to an embodiment, if multiple bodily feeling levels or multiple environment information are received, the server 100 may generate the correlation model of the user based thereon. The server 100 may also derive another correlation model of the user by applying the newly generated correlation module to the correlation mode of the previously visited user group.

For example, the server 100 may acquire the first bodily feeling level of ‘warm’ and the first indoor environment information of 23° C. The server 100 may acquire the second bodily feeling level of ‘hot’ and the second indoor environment information of 25° C.

The server 100 may derive Equation 5 by substituting the first bodily feeling level of 23 and the first environment information value of 1 and the second bodily feeling level of 25 and the second environment information value of 2 to Equation y=ax+b for the correlation model.

y=0.36x−7.14 Equation 5

The server 100 may apply Equation 5 for the correlation model of the user to Equation 1 for the correlation of the visited user group at a predetermined reflection ratio. This correlation model may be expressed by Equation 6.

The server 100 may apply

y=(0.28(1−α)+0.36α)x+(−6.47(1−α)−7.14α) Equation 6

The server 100 may derive Equation 7 by substituting 0.3 for the reflection ratio α in Equation 6. At this time, the reflection ratio is a value in the range from 0 to 1.

y=0.3x−6.67 Equation 7

If the correlation model of the user is determined, the server 100 may determine the setting value corresponding to the bodily feeling level of ‘comfort’ using the correlation model at operation S406-2.

That is, the server 100 may substitute the level value of 0 corresponding to ‘comfort’ for y in Equation 7.

With this substitution, the correlation model of the user may be expressed by Equation 8.

0=0.3x−6.67 Equation 8.

From Equation 8, x becomes 22.23. That is, the server 100 may set the setting value corresponding to the bodily feeling level of ‘comfort’ to 22.23 in Equation 7. The server 100 may determine the value of x as the target indoor temperature as the second setting value.

The server 100 may store the setting value matching the bodily feeling level of ‘comfort’ derived through the new and old correlation models of the user in its storage.

Returning to FIG. 2, the server 100 may control the indoor device 200 to operate with the second setting value. For example, the second setting value may be transmitted from the server 100 to the gateway 110 at operation S206. The gateway 110 may forward the second setting value to the indoor device 200 at operation S207.

If the second setting value is received, the indoor device 200 may operate with the second setting value at operation S208.

Meanwhile, an indoor display device may display the bodily feeling level corresponding to the indoor temperature on the screen as the indoor temperature varies. For example, the bodily feeling level may be updated periodically or whenever the indoor temperature changes. The indoor display device may be a device with a display (e.g., TV) or the gateway 110 with a display.

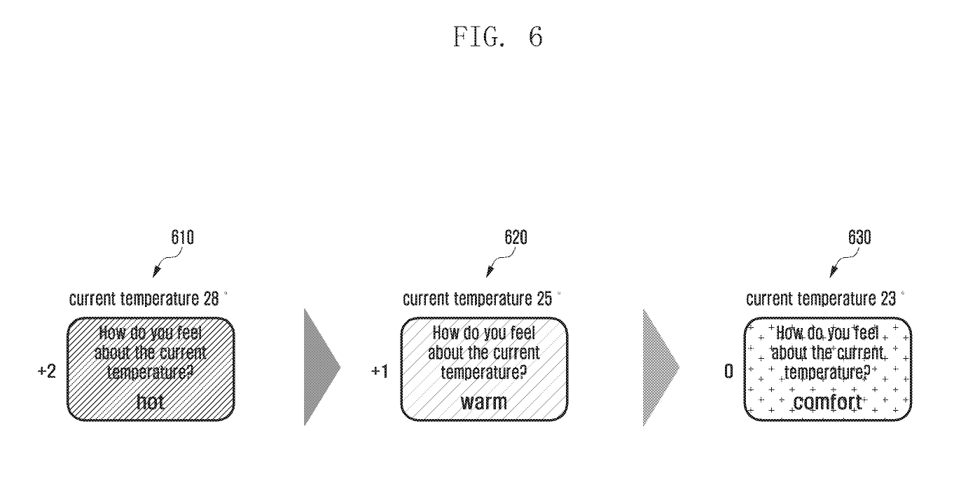

FIG. 6 is a diagram illustrating screen displays for explaining change of the bodily feeling level as the indoor temperature changes according to an embodiment of the present disclosure.

Referring to FIG. 6, the display device having a screen displaying the bodily feeling level may be one of the indoor devices equipped with a display. The display device may be the gateway 110 with a display. Although the description is directed to the case where the device displaying the bodily feeling level is a display device (e.g., TV) with a function of the gateway 110 for convenience of explanation, the present disclosure is not limited thereto.

Part 610 of FIG. 6 shows a screen displaying a question asking for the feeling of the user about the current temperature. For example, if the current temperature is 28° C., the user may feel hot at the temperature. In this case, the user may select the bodily feeling level of ‘hot’ on the user interface of the display device. At this time, the user interface may receive one of various types of user inputs including, but not limited to, a user input by means of a remote controller, a voice input, a gesture input, a touch input a button input, and a sightline input. The display device may display the bodily feeling level of ‘hot’ on the screen and transmit the level value of +2 matching the bodily feeling level of ‘hot’ to the server 100. For example, the display device may transmit the bodily feeling level to the server 100.

The server 100 may receive the bodily feeling level from the display device. As described above, it may be possible to determine the temperature of satisfying the user using the correlation model generated based on the use history information.

Next, the server 100 may control the indoor device 200 to achieve the target temperature. In this case, the display device may display the predictive feeling of the user as the temperature changes before reaching the target temperature. For example, if the current temperature is 28° C. and the target temperature for satisfying the user is 23° C., the display device may display the bodily feeling level of ‘warm’ on the screen when the indoor temperature reaches 25° C.

For this purpose, the server 100 may continue applying the indoor temperature to the correlation model as the indoor temperature changes. For example, if y of the correlation model is in the range from −2 to 1.5, the server 100 may estimate the bodily feeling level of ‘cold’. If y of the correlation model is in the range of −1.5 to 0.5, the server 100 may estimate the bodily feeling level of ‘cool’.

In this way, the server 100 may estimate the bodily feeling level of the user as the indoor temperature changes. The server 100 may also transmit the bodily feeling level to the display device.

If the bodily feeling level representing the user's feeling is received, the display device may display the bodily feeling level on the screen as denoted by reference number 620 of FIG. 6.

Next, the if the indoor temperature reaches the target temperature of 23° C. corresponding to the bodily feeling level of ‘comfort’ for the user, the display device may display the bodily feeling level of ‘comfort’ 0 the screen denoted by reference number 630.

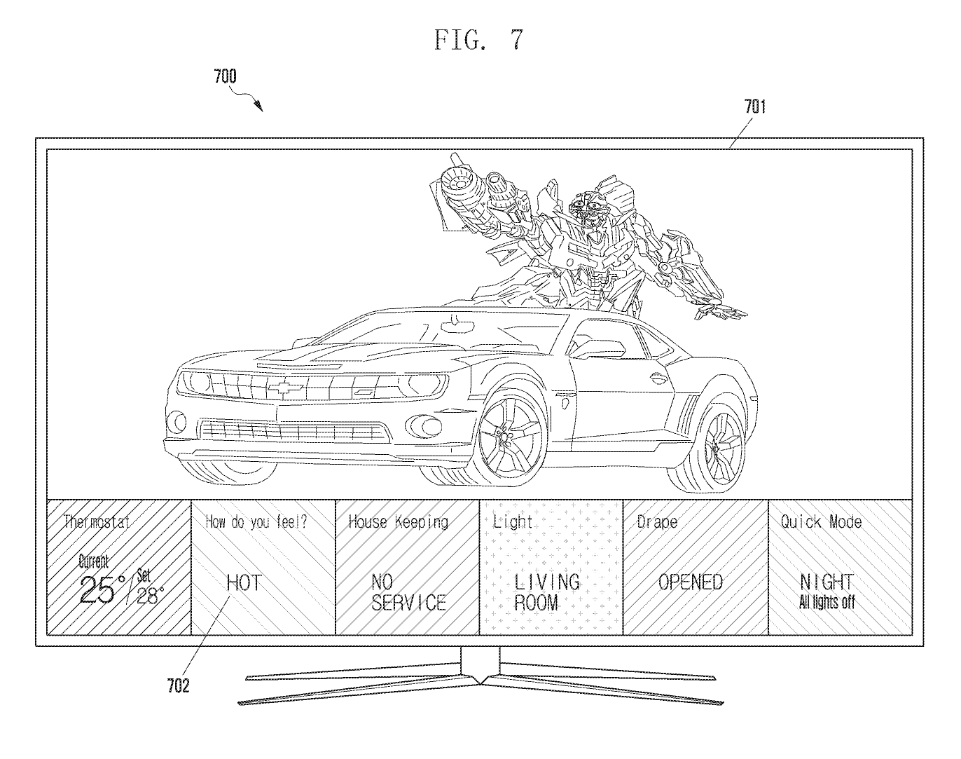

FIG. 7 is a diagram illustrating a screen display for explaining how to select a bodily feeling level for adjusting the temperature according to an embodiment of the present disclosure.

Referring to FIG. 7, the display device 700 may display indoor status information on the screen 701.

The screen 701 may show the bodily feeling level as denoted by reference number 702 in association with the user's feeling about the indoor temperature.

The bodily feeling level 702 associated with the user's feeling may be one of multiple bodily feeling levels constituting the bodily feeling scale. The bodily feeling level 702 may be the bodily feeling level representing the current user's feeling estimated by the server 100.

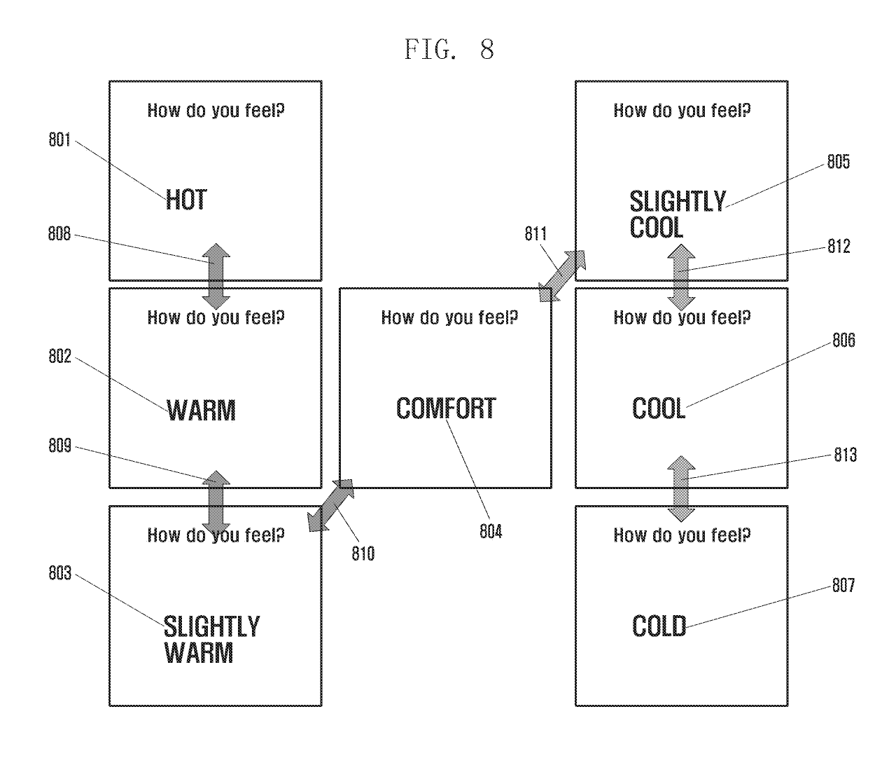

FIG. 8 is a diagram illustrating bodily feeling levels of the bodily feeling scale displayed on the screen of the display device of FIG. 7 according to an embodiment of the present disclosure.

Referring to FIG. 8, the bodily feeling scale consists of the bodily feeling levels 801 to 807 of ‘hot’, ‘warm’, ‘slight warm’, ‘comfort’, ‘slightly cool’, ‘cool’, and ‘cold’. At least one of the bodily feeling levels 801 to 807 may be displayed on the screen 701 as the bodily feeling level related to the feeling of the user.

In this case, the bodily feeling levels 801 to 807 may be displays in sequence. Referring to FIG. 8, the arrows 808 to 813 show transitions available between bodily feeling levels.

For example, if the user navigates to a next bodily feeling level in the state that the first bodily feeling level 802 is displayed on the screen 701, the second bodily feeling level 801 or the third bodily feeling level 803 may be displayed as the next bodily feeling level.

In the case that the bodily feeling level predicting the feeling of the user is displayed on the screen 701, the next bodily feeling level following the first bodily feeling level 802 may be the second bodily feeling level 801 or the third bodily feeling level 803.

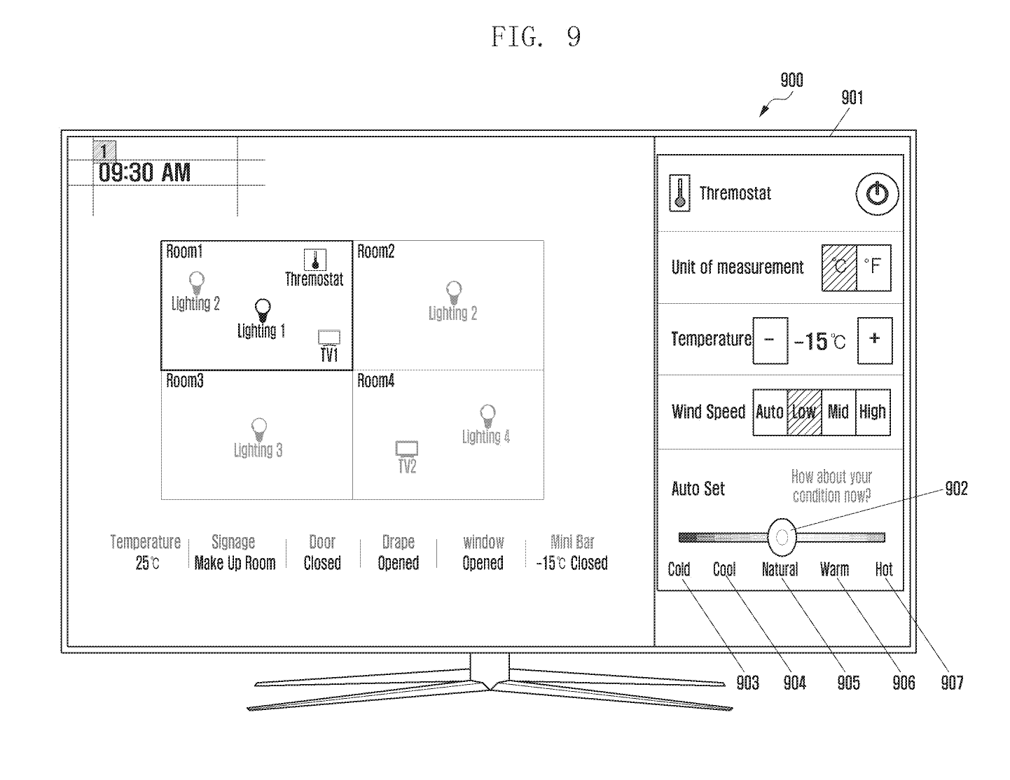

FIG. 9 is a diagram illustrating a screen display for explaining how to select the bodily feeling level to adjust the temperature according to another embodiment of the present disclosure.

Referring to FIG. 9, the display device 900 may display the indoor status information on the screen. The screen 901 may display a bodily feeling level UI element 902 for receiving the user's feeling about the indoor temperature. In this case, the user may select one of the bodily feeling levels using the bodily feeling scale UI element 902. At this time, the bodily feeling scale may consist of multiple bodily feeling levels (e.g., 20 to 100). The user may navigate the bodily feeling levels in an indiscrete manner. In order to facilitate selecting the target bodily level on the bodily feeling scale, it may be possible to present the representative bodily feeling levels 903 to 907 on the screen 901.

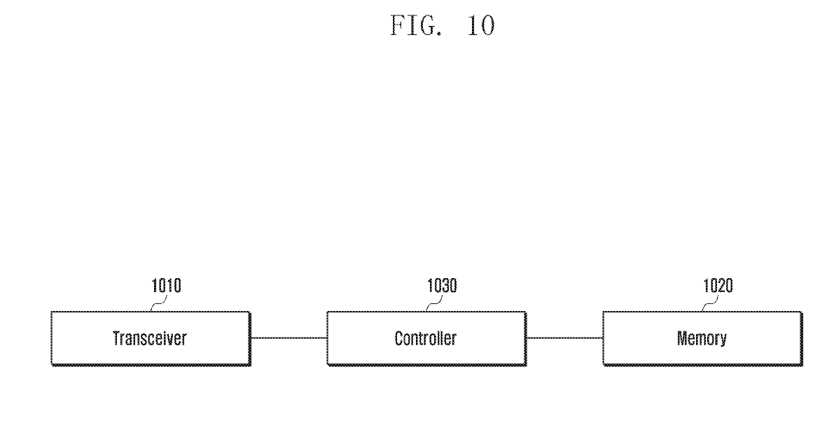

FIG. 10 is a block diagram illustrating a configuration of the server 100 according to an embodiment of the present disclosure.

Referring to FIG. 10, the server 100 may include a communication unit 1010, a storage unit 1020, and a control unit 1030.

The communication unit 1010 is connected to at least one of the gateway 110 and the indoor device 200 to exchange information. For example, the server 100 may be connected to at least one of the gateway 110 and the indoor device 200 wirelessly by means of the communication unit 1010. The communication unit 1010 may include at least one of a wireless local area network (WLAN) module and a short range communication module. The WLAN module may connect to the Internet or another device via an access point (AP) under the control of the control unit 1030. The WLAN module may support the Institute of Electrical and Electronics Engineers WLAN standards (IEEE 802.11x). The short range communication module may perform short range communication with another device under the control of the control unit 1030. The short range communication module may support at least one of Bluetooth, infrared data association (IrDA), near field communication (NFC), Wi-Fi, z-wave, Wi-Fi-Direct, and ZigBee.

The storage unit 1020 of the server 100 may store the use history information of the device of the same kind of the indoor device 200. The use history information may include bodily feeling levels concerning the heterogeneous devices, setting values matching the bodily feeling levels, indoor environment information in controlling the heterogeneous device, and bodily feeling levels of previously visited users according to the setting value.

The server 100 may receive the first bodily feeling level selected by the user by means of the communication unit 1010. Next, the server 100 may determine the second setting value corresponding to the second level based on the indoor environment information and the use history information of the second stored in the storage unit 1020 and control the indoor device to operate with the second setting value. For example, the server 100 may transmit the second setting value to the indoor device directly or via the gateway 110 by means of the communication unit 1010.

The control unit 1030 of the server 100 may receive the first bodily feeling level selected by the first user among the bodily feeling levels in the state that the indoor device is operating with the first setting value, determine the second setting value corresponding to the second bodily feeling based on the first bodily feeling level, indoor environment information, and the use history information with which the second user has control the devices of the same kind as the indoor device, and control the indoor device to operate with the second setting value.

The control unit 1030 may transmit the second setting value to the indoor device directly or via the gateway by means of the communication unit 1010 to control the indoor device to operate with the second setting value. The control unit 1030 may determine the second setting value matching the second level based on the user information of the first user.

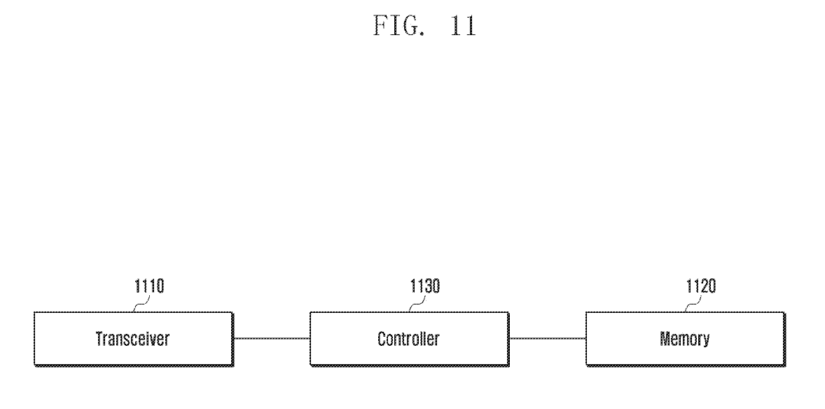

FIG. 11 is a block diagram illustrating a configuration of the gateway according to an embodiment of the present disclosure. Although the description is directed to the case where the bodily feeling scale is displayed by a display device (e.g., TV) having the function of the gateway 110, the present disclosure is not limited thereto.

Referring to FIG. 11, the gateway 110 may include a communication unit 1110, a storage unit 1120, and a control unit 1130.

The gateway 110 may be implemented as an independent device separated physically from other indoor devices or embedded in an indoor device. For example, the functionality of the gateway 110 may be embedded in one of a TV, a set-top box, a personal computer (PC), a tablet PC, a mobile phone, a robot cleaner, a refrigerator, and a thermostat.

The communication unit 1110 is responsible for communication with the server 100 and the indoor device 200. The communication unit 1110 may include at least one of a WLAN module and a short range communication module. The WLAN module may connect to the Internet or another device via an AP under the control of the control unit 1130. The WLAN module may support the IEEE 802.11x. The short range communication module may perform short range communication with another device under the control of the control unit 1130. The short range communication module may support at least one of Bluetooth, IrDA, NFC, Wi-Fi, z-wave, Wi-Fi-Direct, and ZigBee.

The gateway 110 may transmit to the server 100 the information received from the indoor device 200 (e.g., setting value, environment information, and bodily feeling level). The gateway 110 may also transmit to the indoor device 200 the information received from the server 100 (e.g., setting value and bodily feeling level).

The gateway 110 may further include a display unit (not shown).

The display unit may display the environment information, bodily feeling scale (levels), and setting value information. For example, the display unit may display the bodily feeling level which is updated as the indoor temperature changes. The display unit may also display a screen showing the user's feeling about the current temperature.

The gateway 110 may further include an input unit (not shown).

The input unit may receive a user input made through a user interface. For example, the input unit may receive the user input such as voice input, gesture input, touch input, button input, and sightline input made through the user interface.

The gateway 110 may control the display unit to display a screen presenting a question asking for the user's feeling about the indoor temperature. Next, the gateway 110 may select a bodily feeling level on the indoor temperature which the user enters by means of the input unit. The gateway 110 may transmit the selected bodily feeling level to the server 100.

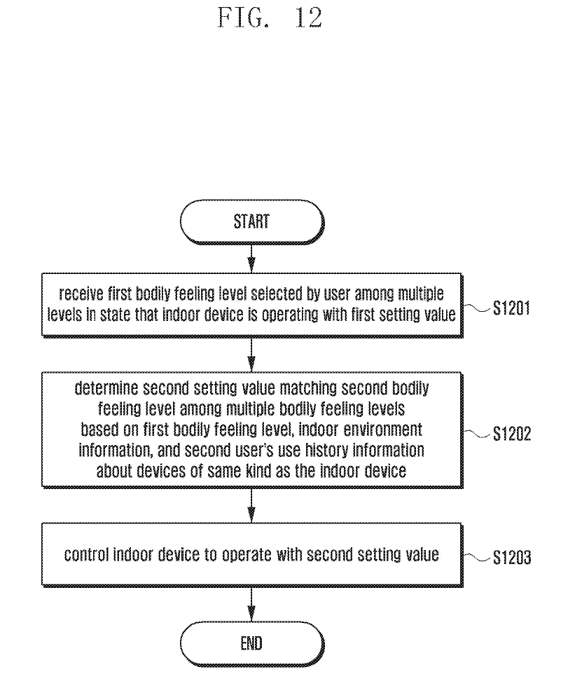

FIG. 12 is a flowchart illustrating an indoor device control procedure of a server according to an embodiment of the present disclosure.

Referring to FIG. 12, it is assumed that the indoor device 200 is operating with a first setting value. In this state, the server 100 may receive a first bodily feeling level selected, by the user, among multiple bodily feeling levels at operation S1201. The first bodily feeling level may include the information indicating the feeling of the user about the indoor environment in which the indoor device 200 operates with the first setting value. At this time, the server 100 may determine a second setting value matching the second bodily feeling level on the bodily feeling scale based on the first bodily feeling level, indoor environment information, and second user's use history information about the devices of the same kind as the indoor device 200 at operation S1202. At this time, the second bodily feeling level may indicate the indoor environment which makes the user feel comfortable.

Next, the server 100 may control the indoor device 200 to operate with the second setting value at operation S1203. For example, the server 100 may transmit the second setting value to the indoor device 200 directly or via the gateway 110.

As described above, the method and apparatus of controlling an indoor device of the present disclosure is advantageous in terms of improving user's indoor device manipulation convenience in such a way that a server provides the user with preset values of the indoor devices automatically in consideration of the user's emotional state.

Also, the method and apparatus of controlling an indoor device of the present disclosure is advantageous in terms of improving user's accessibility to the indoor devices in such a way that a server provides the user with preset values of the indoor devices which represent a plurality levels of the user's emotional state.

Also, the method and apparatus of controlling an indoor device of the present disclosure is advantageous in terms of reducing power consumption of the indoor devices in such a way that a server provides the user with preset values of the indoor devices automatically to minimize trial and error of the user.

The present disclosure relates to the sensor network, Machine to Machine (M2M), Machine Type Communication (MTC), and Internet of Things (IoT) technologies. The present disclosure can be applied to intelligent services (such as smart home, smart building, smart city, smart car or connected car, health care, digital education, retail business, and security and safety service).

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling an indoor device via a server, the method comprising:
receiving, when the indoor device operates with a first setting value, a first bodily feeling level selected by a first user among a plurality of bodily feeling levels;
determining a second setting value matching a second bodily feeling level among the plurality of bodily feeling levels based on the first bodily feeling level, indoor environment information, and use history information on a control made, by a second user, to homogeneous devices of the indoor device; and
controlling the indoor device to operate with the second setting value.

2. The method of claim 1, wherein the use history information comprises a bodily feeling level used by the second user for controlling the homogeneous devices and a setting value determined based on the bodily feeling level.

3. The method of claim 1, wherein the second user is a user who is different from the first user and has controlled the homogeneous devices.

4. The method of claim 1, wherein the use history information comprises information on the use of the homogeneous devices by the second user in at least one of identical and similar situations to the indoor situation.

5. The method of claim 1, wherein the second setting value is determined based on user information of the first user.

6. The method of claim 1, wherein the indoor environment information comprises at least one of indoor temperature, indoor brightness, indoor sound, indoor airflow amount, and indoor sunlight amount.

7. The method of claim 1, wherein the first bodily feeling level comprises information on feeling of the user about indoor environment.

8. The method of claim 1, wherein controlling the indoor device comprises transmitting the second setting value to the indoor device directly or via a gateway.

9. The method of claim 1, wherein the indoor device is one of a thermostat, an air conditioner, and a heater for adjusting indoor temperature.

10. The method of claim 1, wherein the plurality of bodily feeling levels comprises at least one of ‘hot’, ‘warm’, ‘comfort’, ‘cool’, and ‘cold’.

11. A server for controlling an indoor device, the server comprising:
a transceiver configured to transmit and receive necessary information; and
a processor configured to:
control the transceiver to receive, when the indoor device operates with a first setting value, a first bodily feeling level selected by a first user among a plurality of bodily feeling levels,
determine a second setting value matching a second bodily feeling level among the plurality of bodily feeling levels based on the first bodily feeling level, indoor environment information, and use history information on a control made, by a second user, to homogeneous devices of the indoor device, and
control the indoor device to operate with the second setting value.

12. The server of claim 11, wherein the use history information comprises a bodily feeling level used by the second user for controlling the homogeneous devices and a setting value determined based on the bodily feeling level.

13. The server of claim 11, wherein the second user is a user who is different from the first user and has controlled the homogeneous devices.

14. The server of claim 11, wherein the use history information comprises information on the use of the homogeneous devices by the second user in at least one of identical and similar situations to the indoor situation.

15. The server of claim 11, wherein the processor is further configured to determine the second setting value based on user information of the first user.

16. The server of claim 11, wherein the indoor environment information comprises at least one of indoor temperature, indoor brightness, indoor sound, indoor airflow amount, and indoor sunlight amount.

17. The server of claim 11, wherein the first bodily feeling level comprises information on feeling of the user about indoor environment.

18. The server of claim 11, wherein the processor is further configured to control transmitting the second setting value to the indoor device directly or via a gateway.

19. The server of claim 11, wherein the indoor device is one of a thermostat, an air conditioner, and a heater for adjusting indoor temperature.

20. The server of claim 11, wherein the plurality of bodily feeling levels comprises at least one of ‘hot’, ‘warm’, ‘comfort’, ‘cool’, and ‘cold’.
